(19) United States
(12) Patent Application Publication
(10) Pub. No.: US 2024/0017739 A1
(43) Pub. Date: Jan. 18, 2024

(54) LIDAR-BASED OBJECT DETECTION APPARATUS AND AUTONOMOUS DRIVING CONTROL APPARATUS HAVING THE SAME

(71) Applicants: HYUNDAI MOTOR COMPANY, Seoul (KR); KIA CORPORATION, (US)

(72) Inventors: Mi Rim Noh, Jeonju-si (KR); Jin Won Park, Seoul (KR)

(73) Assignees: Hyundai Motor Company, Seoul (KR); KIA CORPORATION, Seoul (KR)

(21) Appl. No.: 18/124,150

(22) Filed: Mar. 21, 2023

(30) Foreign Application Priority Data
Jul. 14, 2022 (KR) 10-2022-0086855

(51) Int. Cl. B60W 60/00; G01C 21/30; G06V 20/58

(52) U.S. Cl. CPC B60W 60/001; G01C 21/30; G06V 20/58; B60W 2420/52; B60W 2554/4029

(57) ABSTRACT

A Light Detection And Ranging (LiDAR)-based object detection apparatus comprising a LiDAR sensor configured to obtain a point cloud, and a processor configured to detect at least one object of interest from the point cloud, wherein the processor is configured to perform determining representative points from LiDAR points corresponding to the object among the point cloud, determining outer points among the representative points, the outer points defining an outline of the object, and determining a confidence score for each of segments connecting at least two of the outer points.

### CROSS-REFERENCE TO RELATED APPLICATION

The present application claims priority to Korean Patent Application No. 10-2022-0086855, filed on Jul. 14, 2022 in the Korean Intellectual Property Office, the entire contents of which is incorporated herein by reference in its entirety.

### TECHNICAL FIELD

The present disclosure relates to a Light Detection And Ranging (LiDAR)-based object detection apparatus and an autonomous driving control apparatus having the same.

### BACKGROUND

The statements in this section merely provide background information related to the present disclosure and may not constitute prior art.

For example, an autonomous vehicle performs autonomous driving by detecting objects of surrounding environment thereof by use of a sensor(s) such as LiDAR, a camera, a radar, etc., planning a driving strategy according to the detection result, and controlling components thereof such as the steering wheel, the brake, the driving motor, etc.

LiDAR-based object detection is very important in autonomous driving, and thus it is obvious that the reliability of the detection gives a great affect to the whole reliability of the autonomous driving.

The Korean Patent Publication No. 10-2021-0124789 discloses LiDAR-based object detection techniques in which representative points are determined from a point cloud of an object of interest, outer points are determined from the representative points, and information on an outline formed by segments connecting the outer points is output to be used for autonomous driving.

However, the object detection according to the conventional techniques neither gives information regarding reliability for the segments nor consider cases in which the reliability is very poor, and thus needs to be improved.

For example, when performing a map-matching process of matching sensor-based detection data with high definition (HD) map data by the conventional techniques, because segments of low reliability are used, it causes a problem that the reliability of the map-matching result and the reliability of a result of localizing the ego vehicle based thereon falls greatly.

The information included in this Background of the present disclosure section is only for enhancement of understanding of the general background of the present disclosure and may not be taken as an acknowledgement or any form of suggestion that this information forms the prior art already known to a person skilled in the art.

### BRIEF SUMMARY

One of objectives of the present disclosure is to provide an improved result in a LiDAR-based object detection and thus provide a result of autonomous driving control with high reliability.

The technical problems-to-solve of embodiments of the present disclosure are not limited to that (or those) mentioned above, and other technical problems-to-solve which are not mentioned here may be obviously understood to any skilled person in the field of the present disclosure.

Various aspects of the present disclosure are directed to providing a Light Detection And Ranging (LiDAR)-based object detection apparatus comprising a LiDAR sensor configured to obtain a point cloud, and a processor configured to detect at least one object of interest from the point cloud, wherein the processor is configured to perform determining representative points from LiDAR points corresponding to the object among the point cloud, determining outer points among the representative points, the outer points defining an outline of the object, and determining a confidence score for each of segments connecting at least two of the outer points.

In at least one embodiment, the determining of outer points includes determining a number of the outer points as N, determining both end points among the representative points, determining one of the both end points as a 1^{st} outer point and the other one of the both end points as an N^{th} outer point, and determining 2^{nd} to N−1^{th} outer points by selecting among the representative points in a sequential order starting from the 1^{st} outer point toward the N^{th} outer point.

In at least one embodiment, the confidence score of a segment is determined to be lower than others, in response to one or more of: a first determination that the segment is a segment connecting the N−1th and Nth outer points which is longer than a first predetermined length (referred to as ‘first case’), a second determination that the segment is a segment other than the last segment which is longer than a second predetermined length (referred to as ‘second case’), a third determination that an angle between the segment and an adjacent segment sharing one outer point with the segment is less than or equal to a first predetermined angle (referred to as ‘third case’), a fourth determination that the segment has a predetermined middle region which does not have a representative point (referred to as ‘fourth case’) and a fifth determination that the segment includes at least one representative point which is not vertically overlapped in a region of the segment in a coordinate system representing the point cloud (referred to as ‘fifth case’).

In at least one embodiment, the confidence score of the segment is determined to be 0 and the other are determined to be 1.

In at least one embodiment, in response to the representative points located below or equal to a predetermined height from ground, the processor performs one or more of: the fourth determination and the fifth determination.

In at least one embodiment, only when a longitudinal length of the object is lower than or equal to a first predetermined value, the processor performs one or more of: the fourth determination and the fifth determination.

In at least one embodiment, the processor is configured to determine the confidence score only when a longitudinal length of the object is longer than or equal to a second predetermined value.

In at least one embodiment, the processor is configured to transmit shape information and the confidence score of each segment to a second processor for a localization of a vehicle based on the shape information and the confidence score of each segment and controlling the vehicle based on the localization.

Also, various aspects of the present disclosure are directed to providing an autonomous driving control apparatus comprising a Light Detection And Ranging (LiDAR) sensor configured to obtain a point cloud, a first processor configured to detect at least one object of interest from the point cloud, and a second processor configured to perform a map-matching process of matching data of the object received from the first processor with a high definition (HD) map data, wherein the first processor is configured to determine representative points from LiDAR points corresponding to the object among the point cloud, determine outer points among the representative points, the outer points defining an outline of the object, and determine a confidence score for each of segments connecting at least two of the outer points, and wherein the second processor is configured to perform the map-matching process using shape information of the segments and the confidence score.

In at least one embodiment, the determining of outer points includes determining a number of the outer points as N, determining both end points among the representative points, determining one of the both end points as a 1^{st} outer point and the other one of the both end points as an N^{th} outer point, and determining 2^{nd} to N−1 outer points by selecting among the representative points in a sequential order starting from the 1^{st} outer point toward the N^{th} outer point.

In at least one embodiment, the confidence score of a segment is determined to be lower than others, in response to one or more of: a first determination that the segment is a segment connecting the N−1th and N^{th} outer points which is longer than a first predetermined length (referred to as ‘first case’), a second determination that the segment is a segment other than the last segment which is longer than a second predetermined length (referred to as ‘second case’), a third determination that an angle between the segment and an adjacent segment sharing one outer point with the segment is less than or equal to a first predetermined angle (referred to as ‘third case’), a fourth determination that the segment has a predetermined middle region which does not have a representative point (referred to as ‘fourth case’) and a fifth determination that the segment includes at least one representative point which is not vertically overlapped in a region of the segment in a coordinate system representing the point cloud (referred to as ‘fifth case’).

In at least one embodiment, the confidence score of the segment is determined to be 0 and the others are determined to be 1.

In at least one embodiment, in response to the representative points located below or equal to a predetermined height from ground.

In at least one embodiment, when a longitudinal length of the object is lower than or equal to a first predetermined value, the first processor performs one or more of: the fourth determination and the fifth determination.

In at least one embodiment, the processor is configured to determine the confidence score only when a longitudinal length of the object is greater than or equal to a second predetermined value.

In at least one embodiment, the confidence score is determined to be 0 or 1, and wherein the second processor is configured to perform the map-matching process by excluding the shape information of segments having the confidence score of 0.

In at least one embodiment, the second processor is configured to perform a localization using a result of the map-matching.

According to an embodiment of the present disclosure, an improved object detection result may be obtained, and thus a reliability-improved autonomous driving may be accomplished by using the detection result.

The methods and apparatuses of the present disclosure have other features and advantages which will be apparent from or are set forth in more detail in the accompanying drawings, which are incorporated herein, and the following Detailed Description, which together serve to explain certain principles of the present disclosure.

### BRIEF DESCRIPTION OF THE DRAWINGS

FIG. 1 represents a conceptual diagram of a LiDAR-based object detection apparatus and an autonomous driving control apparatus of an embodiment of the present disclosure.

FIG. 2 represents a flowchart of a LiDAR-based object detection and a controlling process for autonomous driving according to an embodiment of the present disclosure.

FIG. 3 represents a conceptual drawing for a segment of a first case among LiDAR outer point segments.

FIG. 4 represents a conceptual drawing for a segment of a second case among LiDAR outer point segments.

FIG. 5 represents a conceptual drawing for a segment of a third case among LiDAR outer point segments.

FIG. 6 represents a conceptual drawing for a segment of a fourth case among LiDAR outer point segments.

FIG. 7 represents a conceptual drawing for a segment of a fifth case among LiDAR outer point segments.

FIG. 8 represents exemplary actual LiDAR representative points, outer points determined therefrom under a upper limit condition for the number of outer points, and a result of confidence scores (shown as 0 or 1 in FIG. 8) being assigned to respective segments.

FIG. 9 represents a first exemplary result of map-matching actual LiDAR data with HD map data.

FIGS. 10A-10B represent a second exemplary result of map-matching actual LiDAR data with HD map data.

FIGS. 11A-11C represent a third exemplary result of map-matching actual LiDAR data with HD map data.

It may be understood that the appended drawings are not necessarily to scale, presenting a somewhat simplified representation of various features illustrative of the basic principles of the present disclosure. The specific design features of the present disclosure as included herein, including, for example, specific dimensions, orientations, locations, and shapes will be determined in part by the particularly intended application and use environment.

In the figures, reference numbers refer to the same or equivalent parts of the present disclosure throughout the several figures of the drawing.

### DETAILED DESCRIPTION

Reference will now be made in detail to various embodiments of the present disclosure(s), examples of which are illustrated in the accompanying drawings and described below. While the present disclosure(s) will be described in conjunction with exemplary embodiments of the present disclosure, it will be understood that the present description is not intended to limit the present disclosure(s) to those exemplary embodiments of the present disclosure. On the other hand, the present disclosure(s) is/are intended to cover not only the exemplary embodiments of the present disclosure, but also various alternatives, modifications, equivalents and other embodiments, which may be included within the spirit and scope of the present disclosure as defined by the appended claims.

In case where identical elements are included in various embodiments, they will be given the same reference numerals, and redundant description thereof will be omitted. In the following description, the terms “module” and “unit” for referring to elements are assigned and used interchangeably in consideration of convenience of explanation, and thus, the terms per se do not necessarily have different meanings or functions.

Furthermore, in describing the exemplary embodiments, when it is determined that a detailed description of related publicly known technology may obscure the gist of the exemplary embodiments, the detailed description thereof will be omitted. The accompanying drawings are used to help easily explain various technical features and it should be understood that the exemplary embodiments presented herein are not limited by the accompanying drawings. Accordingly, the present disclosure should be construed to extend to any alterations, equivalents and substitutes in addition to those which are particularly set out in the accompanying drawings.

Although terms including ordinal numbers, such as “first”, “second”, etc., may be used herein to describe various elements, the elements are not limited by these terms. These terms are generally only used to distinguish one element from another.

When an element is referred to as being “coupled” or “connected” to another element, the element may be directly coupled or connected to the other element. However, it should be understood that another element may be present therebetween. In contrast, when an element is referred to as being “directly coupled” or “directly connected” to another element, it should be understood that there are no other elements therebetween.

A singular expression includes the plural form unless the context clearly dictates otherwise.

In the exemplary embodiment, it should be understood that a term such as “include” or “have” is intended to designate that the features, numbers, steps, operations, elements, parts, or combinations thereof described in the specification are present, and does not preclude the possibility of addition or presence of one or more other features, numbers, steps, operations, elements, parts, or combinations thereof.

Unless otherwise defined, all terms including technical and scientific ones used herein have the same meanings as those commonly understood by one of ordinary skill in the art to which this disclosure belongs. It will be further understood that terms, such as those defined in commonly used dictionaries, should be interpreted as having meanings consistent with their meanings in the context of the relevant art and the present disclosure, and are not to be interpreted in an idealized or overly formal sense unless expressly so defined herein.

Furthermore, the term “unit” or “control unit” included in the names of a hybrid control unit (HCU), a motor control unit (MCU), etc. is merely a widely used term for naming a controller configured for controlling a specific vehicle function, and does not mean a generic functional unit. For example, each controller may include a communication device that communicates with another controller or a sensor to control a function assigned thereto, a memory that stores an operating system, a logic command, input/output information, etc., and one or more processors that perform determination, calculation, decision, etc. necessary for controlling a function assigned thereto.

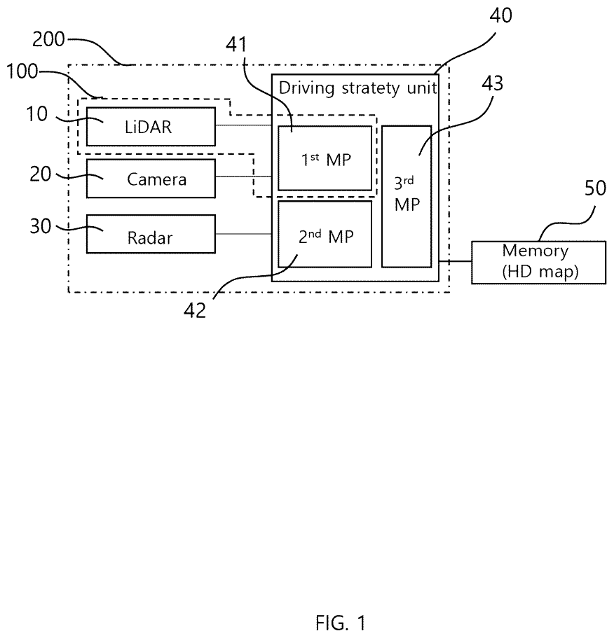

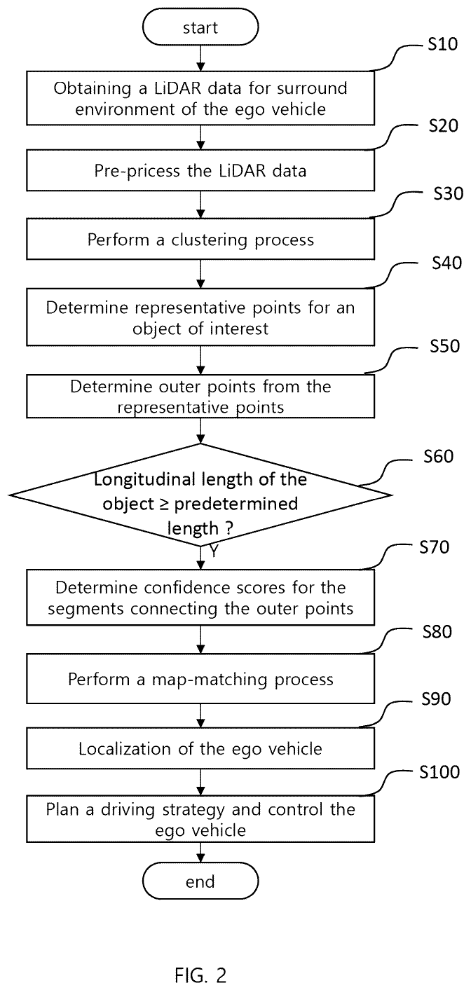

For a brief explanation of the FIGS. in advance before describing in detail a LiDAR-based object detection apparatus and an autonomous driving control apparatus of an embodiment of the present disclosure, FIG. 1 represents a conceptual diagram of a LiDAR-based object detection apparatus and an autonomous driving control apparatus of an embodiment of the present disclosure and FIG. 2 represents a flowchart of a LiDAR-based object detection and a controlling process for autonomous driving according to an embodiment of the present disclosure.

An autonomous vehicle to which a LiDAR-based object detection apparatus and an autonomous driving control apparatus are applied is taken as an example and detailed in the below description, without being limited thereto.

First, as shown in FIG. 1, a LiDAR-based object detection apparatus 100 comprises LiDAR 10 and a first microprocessor 41, and an autonomous vehicle control apparatus 200 comprises the LiDAR 10, the first microprocessor 41, and a second microprocessor 42.

In the present embodiment, the autonomous vehicle control apparatus 200 may further comprise a camera 20 and a radar 30 for sensor fusion, without being limited thereto. Also, the autonomous vehicle control apparatus 200 may further comprise a driving strategy unit 40 and a third microprocessor 43 for planning a driving strategy, without being limited thereto.

Also, in the present embodiment, the first microprocessor 41, the second microprocessor 42, and the third microprocessor 43 are materialized as respective microprocessors separated from each other, without being limited thereto. For example, any two or all of the first, second and third microprocessors 41, 42, 43 may be integrated as one microprocessor.

In FIG. 1, the LiDAR 10 obtains detection data for surrounding environment of the ego vehicle as a point cloud, and is multiple channel 3D LiDAR of which a plurality of detection regions are separately arranged in a vertical direction.

For example, the LiDAR 10 of the present embodiment has 16 or 32 channels.

The respective components in FIG. 1 will be detailed below with detailed description of the flowchart of FIG. 2.

First, step S10 in FIG. 2 is for obtaining a point cloud as LiDAR data for surrounding environment of the vehicle by use of the LiDAR 10, and steps S20-S70 may be performed by the first microprocessor 41, steps S80-S90 may be performed by the second microprocessor 42 and step S100 may be performed by the third microprocessor 43.

In step S10, raw data of the point cloud obtained by the LiDAR 10 may be obtained in a plurality of channels, e.g. 16 or 32 channels.

The raw data obtained by the LiDAR 10 is preprocessed before an object detection process (S20), and thus the raw data is calibrated with a reference point (e.g. the center point of the front bumper) of the vehicle and invalidate data among the raw data is deleted.

For example, points of a low level in signal intensity or reflection rate and points reflected from the ego vehicle are deleted according to information on intensities and confidences of the raw data.

A plurality of layers of LiDAR data may be obtained from the plurality of channels of the LiDAR points, and preferably the number of layers is smaller than that of the channels.

For example, the whole channels may be divided in as many sets as the number of the layers and the point data of each set of channels may be projected onto a corresponding layer which is defined for the corresponding set, and thus LiDAR point data of each layer may be obtained.

The process of obtaining the multiple layer data from the multiple channel data may be performed with the raw data, however, it also may be performed with preprocessed valid data among the raw data.

After the multiple layer LidAR data being obtained, steps S30-S70 are performed for each layer as described below. Each step is detailed now.

First, in step S30, a clustering process is performed through a clustering algorithm for the LiDAR points of each layer according to a predetermined rule. Here, it is preferred that points are clustered as one group per one object.

Next, representative points are determined from LiDAR points of an object of interest clustered in a group (S40).

And, outer points corresponding to the object may be determined from the representative points (S50).

For example, the number of the outer points does not exceed a predetermined upper limit, e.g. N.

Setting the upper limit to the number of outer points is because of the limit of a memory, and also because too many outer points result in too much calculation.

Under a restriction of the upper limit to the number, after the start point is determined as the first outer point and the end point is determined as the N^{th} outer point, the remaining outer points are determined according to a predetermined rule sequentially from the start point toward the end point.

The determining of the representative points and the outer points may be performed by the same process that is disclosed in the U.S. Pat. No. 11,423,546, and thus the detailed description is redeemed to be incorporated herein and the writing is omitted.

Next, whether a longitudinal length of the corresponding object is greater than or equal to a second predetermined value is judged (S60), and if so, the processor proceeds to step S70 described below.

Here, the longitudinal direction means the driving direction of the ego vehicle corresponding to the x axis in a Cartesian coordinate system, a lateral or transverse direction means a left-right direction with respect to the ego vehicle corresponding to the y axis, and a vertical direction means a direction vertical to a driving plane of the ego vehicle corresponding to the z axis.

The longitudinal length of the object may be determined, for example, as a longitudinal length between the start point and the end point of the corresponding cluster.

The second predetermined value may be determined through tests and statistics, preferably as a value which is appropriate to tell relatively long stationary objects such as a guardrail or a road side wall from a moving object such as a vehicle.

For a cluster whose longitudinal length is greater than or equal to the second predetermined value, confidence scores are determined and assigned to segments connecting the outer points (S70).

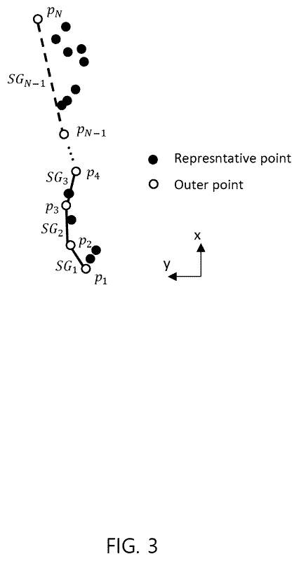

Determining confidence scores for five cases is detailed below with FIGS. 3 to 7. Before the detailed description, it should be noted that the representative and outer points in FIGS. 3 to 7 are assumed LiDAR points.

First, as the first case, as shown in FIG. 3, because of the upper limit of N for the number of outer points, the determining of outer points is terminated even though there are still remaining many representative points of candidates for outer points between the lastly determined N−1^{th} outer point Pₙ₋₁ and the outer point of the end point Pₙ. In this case, the last segment may not be appropriate for information on the outline of the corresponding object and too long segment is not any more appropriate.

In the present embodiment, the length of the last segment SGₙ₋₁ is compared with a first predetermined length and a confidence score is determined and assigned according to a result of the comparison.

For example, if the length of the last segment SGₙ₋₁ exceeds the first predetermined length, then the confidence score of the segment SGₙ₋₁ is determined to be 0.

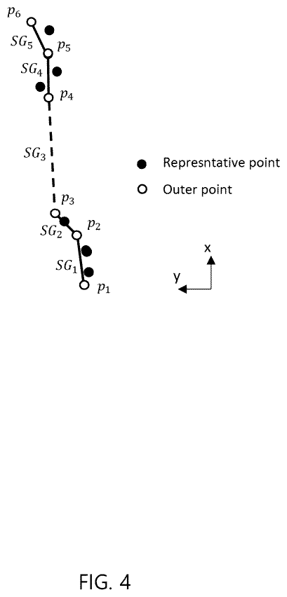

Next, as the second case, as shown in FIG. 4, there is a case where a length of one among middle portion segments is too long. This case may occur due to loss of LiDAR points, and it may not be appropriate to use the segment as information on the outline.

In the present embodiment, the length of the middle segment is compared with a second predetermined length, and a confidence score is determined and assigned according to a result of the comparison. Here, the second predetermined length may be the same as the first predetermined length, without being limited thereto.

For example, if the length of the middle segment exceeds the second predetermined length, the confidence score of the segment is determined to be 0. In FIG. 4, for example, the third segment SG₃ between the third and fourth outer points p₃ and p₄ exceeds the second predetermined length, and thus the confidence score is determined to be 0.

Next, as the third case, there may be an outer point which is distant from other outer points, and it is probable that the corresponding outer point may be a LiDAR point of other object, and thus the segment is not appropriate as information on the outline of the corresponding object.

For this case, an angle between both segments of an outer point is used, and confidence scores of the corresponding segments are determined according to a result of comparison between the angle and a first predetermined angle.

For example, if an angle between two adjacent segments is below or equal to the first predetermined angle, then the confidence scores of the segments are determined to be 0.

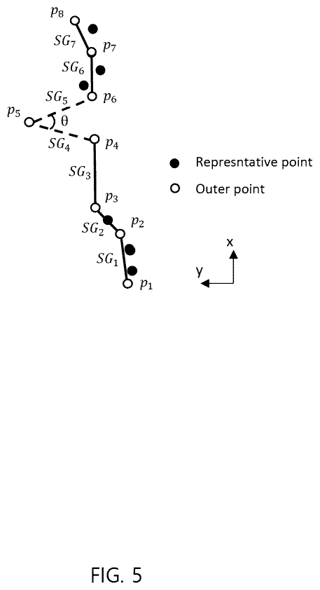

For example, in FIG. 5, because the angle θ between the both segments, i.e. the fourth segment SG₄ and the fifth segment SG₅ is below the first predetermined angle, the confidence scores are determined to be 0.

Next, as the fourth case, it is a case where there are representative points between two adjacent outer points, however, there is not in a predetermined middle region. In a case where a part of the representative points are located separately from other part of the representative points in the same cluster, the segment connecting the two separated parts may not be appropriate for information on the outline and the fourth case is for his case.

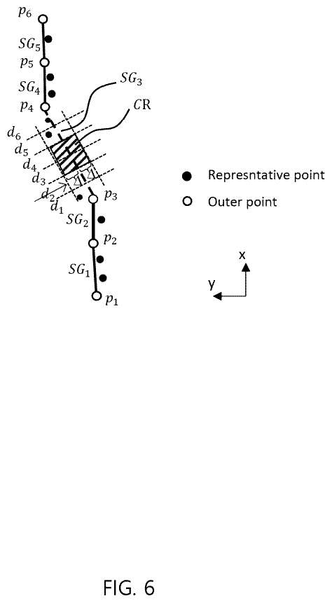

To this end, for example, as shown in FIG. 6, a predetermined region CR is determined by the two middle regions d₃ and d₄ among the six regions d₁ to d₆ dividing perpendicularly the region between the third outer point p₃ and the fourth outer point p₄ and parallel lines distant in a transverse direction by a predetermined distance Δ at both sides from the third segment SG₃, and if there is no representative point therein, then the confidence score of the third segment SG₃ is determined to be 0.

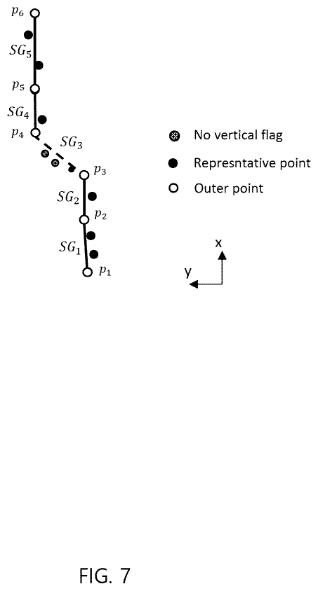

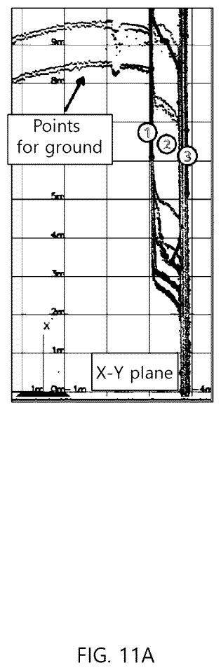

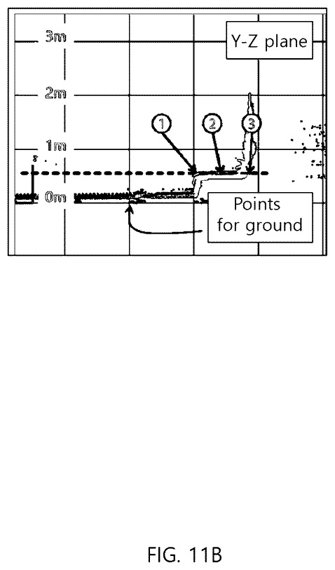

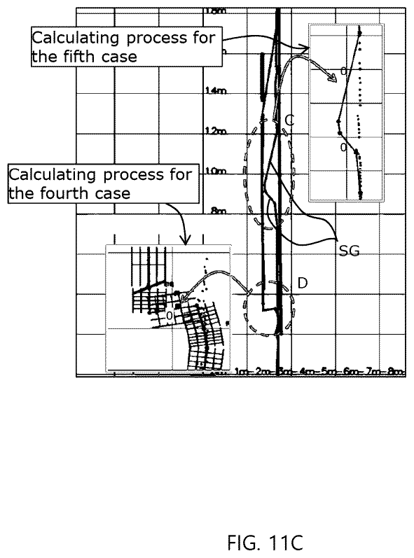

Next, as the fifth case, as shown in FIG. 7, it is a case where although there is a representative point between two adjacent outer points, there is no corresponding LiDAR point in other channel or layer. For example, in a case where there is a sidewalk for pedestrian, LiDAR points reflected from the surface thereof may be included (as shown in FIG. 11), and the fifth case is for this case.

Where there are LiDAR points at the locations of an identical x-y coordinate through a plurality of channels, the corresponding points may be distinguished from others by a vertical flag being assigned thereto, and as shown in FIG. 7, if there is a representative point with no vertical flag assigned, then, for example, the confidence score of the segment between the outer points at the both side of the representative point is determined to be 0.

In the present embodiment, if a segment corresponds to at least one of the five cases, then the confidence score of the segment is determined to be 0 and the confidence scores of other segments, i.e. segments which do not correspond to any one of the five cases are determined to be 1.

For example, segments of confidence score of 0 may be treated as invalid as information on the outline of the corresponding object, and segments of confidence score of 1 may only be treated to be used as information on the outline of the corresponding object.

In the flowchart of FIG. 2, though not shown, steps from S30 to S70 may be performed per each layer data.

The fourth case and the fifth case may be applied for LiDAR points below or equal to a predetermined height. That is, only for LiDAR data of layers below or equal to the predetermined height among the layers are applied the fourth case and the fifth case. Because the fourth case and the fifth case are for relatively low stationary objects, applying to the layers over the predetermined height only results in increasing an amount of calculation.

Further, the fourth case and the fifth case may be set to be applied only when the longitudinal length is smaller than or equal to a first predetermined value.

Next, in step S80, a map-matching process of matching shape information of the segments including the outer points and the confidence scores with HD map data is performed.

For example, the HD map data may be received from an external map server and stored in the memory 50 for a range of a predetermined distance with respect to the ego vehicle.

The map-matching process may be performed by the second microprocessor 42 in FIG. 1, and to this end, the second microprocessor 42 may receive object detection information from the first microprocessor 41 and read necessary HD map data in from the memory 50.

And, a result of the map-matching may be used for localization of the ego vehicle, and the vehicle location determined by the localization may be used for planning a driving strategy, and a control of the vehicle is performed according to the planned strategy.

The LiDAR-based object detection and the autonomous driving control of an embodiment of the present disclosure is described by use of the flowchart of FIG. 2, however, the steps in FIG. 2 are included for the sake of convenience of explanation for better understanding of the present disclosure and thus should not be construed as necessary elements.

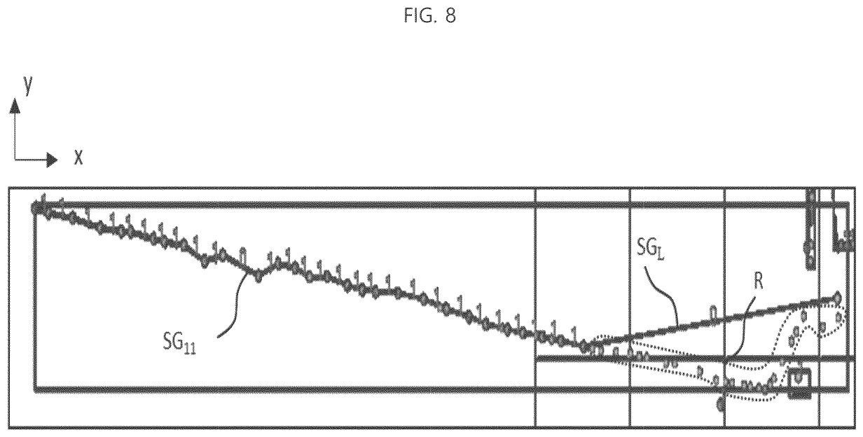

On the other hand, FIGS. 8 to 11 represent exemplary results of applying the embodiment described above and are detailed below.

First, the confidence score of the 11^{th} segment SG₁₁ is determined to be 0 because the length of the segment exceeds the second predetermined length, and also the confidence score of the last segment SG_{L} is determined to be 0 because even though there still remains many representative points (R) of candidates for outer points in-between the both outer points thereof, the segment length exceeds the second predetermined length due to the upper limit to the number of outer points.

The remaining segments in FIG. 8 do not correspond to any of the five cases, and thus the confidence scores thereof are determined to be 1.

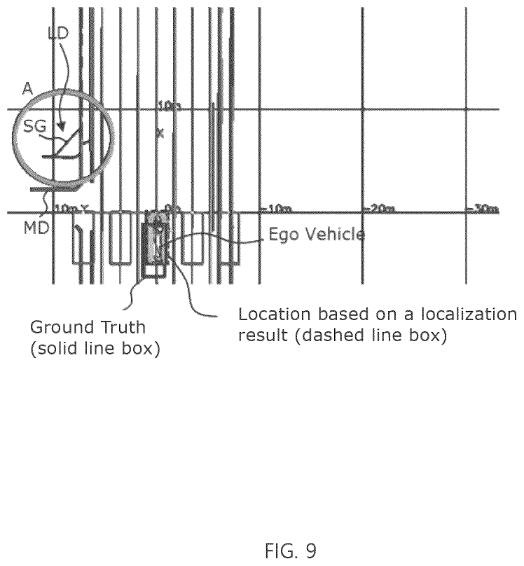

FIG. 9 represents a case where there is an emergency pullout area in a tunnel.

As shown in FIG. 9, a corner portion of the emergency pullout area was not clearly detected due to loss of LiDAR points for an end portion (A) of the emergency pullout area, and thus a segment SG longer than the second predetermined length was formed.

In this case, as shown in FIG. 9, a discrepancy between LiDAR data LD and HD map data MD occurs at the corresponding corner portion, and thus a result of the map-matching may become incorrect.

It is, as shown in FIG. 9, understood that a localization of the ego vehicle carried out based on the incorrect map-matching result may be discrepant from the Ground Truth.

In a case like FIG. 9, if the present embodiment is applied, then the confidence score of the problematic segment SG is determined to be 0, and accordingly the result of the map-matching will become more correct.

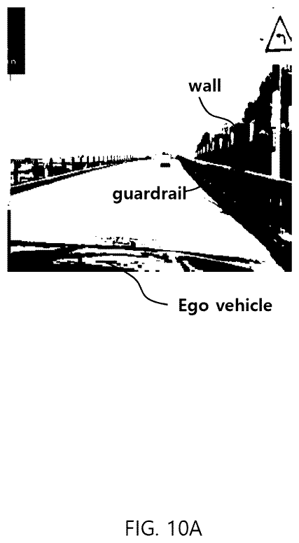

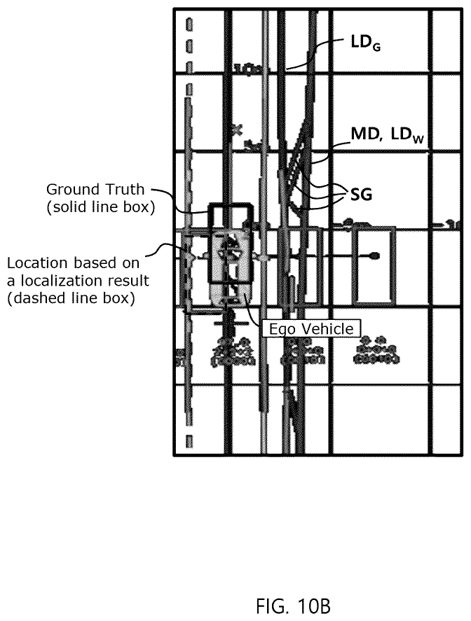

FIGS. 10A-10B represent a case where there is a guardrail to the right of the ego vehicle as a road boundary and there is a road wall immediately behind the guardrail. FIG. 10A shows a picture of the scene taken from the ego vehicle and FIG. 10B represents LiDAR points data for a similar instance.

In FIG. 10B, there are shown segments SG between the LiDAR data of the guardrail LD_{G} and the LiDAR data of the wall LD_{W}, though the space between the two is vacant.

And, if the segments SG are used for the map-matching, then the map-matching result becomes incorrect due to the discrepancy of the shape from the HD map data MD and thus the reliability of the localization performed according to the result falls.

FIG. 10B shows a localization result of the ego vehicle which is discrepant from the actual location (Ground Truth) due to the error segments SG being used for a map-matching process.

If the present embodiment is applied to this case, then because confidence scores of segments between which an angle is smaller than or equal to a first predetermined angle are determined to be 0, the error in the localization can be prevented.

FIGS. 11A-11C represent LiDAR data for a case where there is a sidewalk for pedestrian in a tunnel.

FIG. 11A shows the LiDAR data on a x-y plane, FIG. 11B shows the LiDAR data on a y-z plane, and FIG. 11C shows a process of applying the present embodiment to a layer data of the LiDAR data.

As shown in FIGS. 11A and 11B, there is a sidewalk at a height of about 0.7 m from the ground, 1 representing LiDAR points for the edge of the sidewalk, 2 representing LiDAR points for the ground surface of the sidewalk, 3 representing LiDAR points for the wall.

There is formed a segment connecting the edge of the sidewalk and the wall at the start portion D of the sidewalk, however, as shown in FIG. 11C, the case corresponds to the fourth case and thus the confidence score of the corresponding segment is determined to be 0.

Also, there exist LiDAR points on the ground surface area C and there are formed corresponding segments SG, however, the confidence scores of the segments SG are determined to be 0 because they are not LiDAR points which a vertical flag is assigned to.

The foregoing descriptions of specific exemplary embodiments of the present disclosure have been presented for purposes of illustration and description. They are not intended to be exhaustive or to limit the present disclosure to the precise forms disclosed, and obviously many modifications and variations are possible in light of the above teachings. The exemplary embodiments were chosen and described to explain certain principles of the present disclosure and their practical application, to enable others skilled in the art to make and utilize various exemplary embodiments of the present disclosure, as well as various alternatives and modifications thereof. It is intended that the scope of the present disclosure be defined by the Claims appended hereto and their equivalents.

What is claimed is:

1. A Light Detection And Ranging (LiDAR)-based object detection apparatus comprising:
a LiDAR sensor configured to obtain a point cloud; and
a processor configured to detect at least one object of interest from the point cloud,
wherein the processor is configured to perform:
determining representative points from LiDAR points corresponding to the object among the point cloud;
determining outer points among the representative points, the outer points defining an outline of the object; and
determining a confidence score for each of segments connecting at least two of the outer points.

2. The LiDAR-based object detection apparatus of claim 1, wherein the determining of outer points includes:
determining a number of the outer points as N;
determining both end points among the representative points;
determining one of the both end points as a 1^{st} outer point and the other one of the both end points as an N^{th} outer point; and
determining 2^{nd} to N−1^{th} outer points by selecting among the representative points in a sequential order starting from the 1st outer point toward the N^{th} outer point.

3. The LiDAR-based object detection apparatus of claim 2, wherein the confidence score of a segment is determined to be lower than others, in response to one or more of:
a first determination that the segment is a segment connecting the N−1th and Nth outer points which is longer than a first predetermined length,
a second determination that the segment is a segment other than the last segment which is longer than a second predetermined length,
a third determination that an angle between the segment and an adjacent segment sharing one outer point with the segment is less than or equal to a first predetermined angle,
a fourth determination that the segment has a predetermined middle region which does not have a representative point and
a fifth determination that the segment includes at least one representative point which is not vertically overlapped in a region of the segment in a coordinate system representing the point cloud.

4. The LiDAR-based object detection apparatus of claim 3, wherein the confidence score of the segment is determined to be 0 and the others are determined to be 1.

5. The LiDAR-based object detection apparatus of claim 3, wherein in response to the representative points located below or equal to a predetermined height from ground, the processor performs one or more of: the fourth determination and the fifth determination.

6. The LiDAR-based object detection apparatus of claim 5, wherein only when a longitudinal length of the object is shorter than or equal to a first predetermined value, the processor performs one or more of: the fourth determination and the fifth determination.

7. The LiDAR-based object detection apparatus of claim 1, wherein the processor is configured to determine the confidence score only when a longitudinal length of the object is longer than or equal to a second predetermined value.

8. An autonomous driving control apparatus comprising:
a Light Detection And Ranging (LiDAR) sensor configured to obtain a point cloud;
a first processor configured to detect at least one object of interest from the point cloud; and
a second processor configured to perform a map-matching process of matching data of the object received from the first processor with a high definition (HD) map data,
wherein the first processor is configured to:
determine representative points from LiDAR points corresponding to the object among the point cloud;
determine outer points among the representative points, the outer points defining an outline of the object; and
determine a confidence score for each of segments connecting at least two of the outer points,
and wherein the second processor is configured to perform the map-matching process using shape information of the segments and the confidence score.

9. The autonomous driving control apparatus of claim 8, wherein the determining of outer points includes:
determining a number of the outer points as N;
determining both end points among the representative points;
determining one of the both end points as a 1^{st} outer point and the other one of the both end points as an N^{th} outer point; and
determining 2^{nd} to N−1^{th} outer points by selecting among the representative points in a sequential order starting from the 1st outer point toward the N^{th} outer point.

10. The autonomous driving control apparatus of claim 9, wherein the confidence score of a segment is determined to be lower than others, in response to one or more of:
a first determination that the segment is a segment connecting the N−1th and Nth outer points which is longer than a first predetermined length,
a second determination that the segment is a segment other than the last segment which is longer than a second predetermined length,
a third determination that an angle between the segment and an adjacent segment sharing one outer point with the segment is less than or equal to a first predetermined angle,
a fourth determination that the segment has a predetermined middle region which does not have a representative point and
a fifth determination that the segment includes at least one representative point which is not vertically overlapped in a region of the segment in a coordinate system representing the point cloud.

11. The autonomous driving control apparatus of claim 10, wherein the confidence score of the segment is determined to be 0 and the others are determined to be 1.

12. The autonomous driving control apparatus of claim 10, wherein in response to the representative points located below or equal to a predetermined height from ground, the first processor performs one or more of: the fourth determination and the fifth determination.

13. The autonomous driving control apparatus of claim 12, wherein only when a longitudinal length of the object is shorter than or equal to a first predetermined value, the first processor performs one or more of: the fourth determination and the fifth determination.

14. The autonomous driving control apparatus of claim 8, wherein the processor is configured to determine the confidence score only when a longitudinal length of the object is greater than or equal to a second predetermined value.

15. The autonomous driving control apparatus of claim 8, wherein the confidence score is determined to be 0 or 1,
and wherein the second processor is configured to perform the map-matching process by excluding the shape information of segments having the confidence score of 0.

16. The autonomous driving control apparatus of claim 8, wherein the second processor is configured to perform a localization using a result of the map-matching.

17. The LiDAR-based object detection apparatus, wherein the processor is configured to transmit shape information and the confidence score of each segment to a second processor for a localization of a vehicle based on the shape information and the confidence score of each segment and controlling the vehicle based on the localization.
